(19) United States
(12) Patent Application Publication
(10) Pub. No.: US 2019/0106604 A1
(43) Pub. Date: Apr. 11, 2019

(54) RUBBER-BASED SELF-ADHESIVE COMPOUND

(71) Applicant: TESA SE, Norderstedt (DE)

(72) Inventors: Tobias BLOEMKER, Hamburg (DE); Axel BURMEISTER, Hamburg (DE); Kai ELLRINGMANN, Hamburg (DE); Julia SCHWARZBACH, Hamburg (DE)

(21) Appl. No.: 16/097,117

(22) PCT Filed: Apr. 13, 2017
(86) PCT No.: PCT/EP2017/058964

§ 371 Date: Oct. 26, 2018

(30) Foreign Application Priority Data
May 6, 2016 (DE) 10 2016 207 822.4

(51) Int. Cl. C09J 7/38; C09J 7/10

(52) U.S. Cl. CPC C09J 7/383; C08L 65/04; C08L 2205/20; C09J 7/10

(57) ABSTRACT

The invention relates to a self-adhesive compound consisting of a mixture containing: rubber, particularly natural rubber; at least one adhesive resin where said adhesive resins are present at an amount of 40 to 130 phr; and expanded polymer microbeads.

The invention relates to the composition of a (natural) rubber self-adhesive compound and also to the use thereof.

Pressure-sensitive adhesives (PSAs), also referred to as self-adhesive compounds, are known to the relevantly skilled person and are extremely widespread. Pressure-sensitive adhesives in simplified terms are adhesives which under just relatively weak applied pressure permit a permanent bond to the substrate and which after service can be detached again substantially without residue from the substrate.

Adhesive tapes furnished with PSAs, known as pressure-sensitive adhesive tapes, are nowadays in diverse use in the industrial and domestic spheres. Pressure-sensitive adhesive tapes consist customarily of a carrier material, oftentimes a carrier film, which is furnished on one or both sides with a PSA. There are also pressure-sensitive adhesive tapes which consist exclusively of a layer of PSA and no carrier film, and are known as transfer tapes. The composition of the pressure-sensitive adhesive tapes may be very different and is guided by the particular requirements of the various applications. The carriers consist customarily of polymeric films such as, for example, polypropylene, polyethylene or polyester or else of paper, woven fabric or nonwoven.

The self-adhesive compounds or PSAs consist customarily of acrylate copolymers, silicones, natural rubber, synthetic rubber, styrene block copolymers, or polyurethanes. Natural rubber is an elastic polymer deriving from plant products such as, in particular, latex. Natural rubber is processed as an essential raw material into natural rubber adhesives.

In order to establish properties appropriate to the application, PSAs may be modified by admixing of tackifier resins, plasticizers, aging inhibitors, processing assistants, fillers, dyes, optical brighteners and/or stabilizers.

Fillers are used, for example, to raise the cohesion of a PSA. The desired reinforcement of the polymer matrix is frequently the result of a combination of filler/filler interactions and filler/polymer interactions.

Fillers are also an admixture for increasing weight and/or increasing volume in paper, in plastics, and also in adhesives and coating materials, and in other products. The addition of filler often improves the technical usefulness of the products and has an influence on their quality—for example, strength, hardness, etc. The natural organic and inorganic fillers such as calcium carbonate, kaolin, talc, dolomite, and the like are produced mechanically.

With rubber and synthetic elastomers as well, suitable fillers may be used to improve the quality—for example, hardness, strength, elasticity, and elongation. Fillers much in use are carbonates, especially calcium carbonate, but also silicates (talc, clay, mica), siliceous earth, calcium sulfate and barium sulfate, aluminum hydroxide, glass fibers and glass spheres, and also carbon blacks.

Organic and inorganic fillers can be distinguished according to their density. Hence the inorganic fillers which are often used in plastics and also adhesives, such as chalk, titanium dioxide, calcium sulfate, and barium sulfate, increase the density of the composite, since they themselves have a density which is higher than that of the polymer. For a given layer thickness, the weight per unit area is then higher.

Besides these, there are fillers which are able to reduce the overall density of the composite. They include hollow microspheres, very bulky lightweight fillers. The spheres are filled with gases such as air, nitrogen, or carbon dioxide, for example; the shells of the spheres consist of glass or else, with certain products, of a thermoplastic.

Foamed PSA systems, more particularly those foamed with microballoons, have likewise been described in the prior art.

In principle there are two ways in which polymer foams can be produced. One involves the action of a blowing gas, either added as such or resulting from a chemical reaction; the other involves the incorporation into the materials matrix of hollow spheres. Foams produced in the latter way are referred to as syntactic foams.

With a syntactic foam, hollow spheres such as glass spheres or hollow ceramic spheres (microspheres) or microballoons are incorporated in a polymer matrix. As a result, in the case of a syntactic foam, the voids are separate from one another, and the substances (gas, air) present in the voids are separated by a membrane from the surrounding matrix.

Compositions foamed with hollow microspheres are distinguished by a defined cell structure with a uniform size distribution of the foam cells. With hollow microspheres, closed-cell foams without cavities are obtained, which in comparison to open-cell versions are distinguished by features including more effective sealing with respect to dust and liquid media. Furthermore, materials foamed chemically or physically are more susceptible to irreversible collapse under pressure and temperature, and frequently exhibit a lower cohesive strength.

Particularly advantageous properties can be achieved if the microspheres used for foaming comprise expandable microspheres (also referred to as “microballoons”). By virtue of their flexible, thermoplastic polymer shell, foams of this kind possess a greater conformability than those filled with nonexpandable, nonpolymeric hollow microspheres (hollow glass spheres, for example). They are suitable more effectively for compensating manufacturing tolerances, of the kind which are the rule in the case of injection-molded parts, for example, and on the basis of their foam character they are also better able to compensate thermal stresses.

Furthermore, through the selection of the thermoplastic resin of the polymer shell, it is possible to exert further influence over the mechanical properties of the foam. Hence it is possible, for example, to produce foams having greater cohesive strength than with the polymer matrix alone, even if the foam has a lower density than the matrix. Accordingly, typical foam properties such as the conformability to rough substrates can be combined with a high cohesive strength for self-adhesive foams.

DE 10 2013 207 467 A1 discloses a polymer foam with high bond strength and improved compressive strength characteristics. This is accomplished by the polymer foam comprising voids formed by microballoons, and also 2 to 20 vol %, based on the total volume of the polymer foam, of voids surrounded by the polymer foam matrix. A further subject of that application is a method for producing a polymer foam.

Furthermore, pressure-sensitive adhesives which comprise expanded microballoons are known from DE 10 2008 004 388 A1. Essential to the invention is that the peel adhesion of the adhesive comprising the expanded microballoons is reduced by at most 30%, preferably at most 20%, more preferably 10% in comparison to the peel adhesion of an adhesive of identical weight per unit area and identical formulation that has been defoamed by the destruction of the voids resulting from the expanded microballoons.

Floor coverings, examples being carpets, PVC floor coverings, or the like, are generally fastened using solventborne, liquid contact adhesives in areas exposed to particularly high foot traffic. This is so, for example, for the area of the footways in public transport vehicles such as aircraft, buses or trains. When such a floor covering is laid, the subsurface is coated with corresponding contact adhesives, and the backing of the floor covering itself is also coated in this way, with a firm bond being achieved when these two adhesive-coated components are married together.

This known procedure is, on the one hand, laborious; on the other hand, the liquid contact adhesives in question customarily include solvents, which ought to be avoided, since firstly they may be harmful to health and secondly they may even represent an explosion hazard. In aircraft in particular, therefore, the use of solventborne adhesives is regarded very critically.

Another possibility is that of bonding floor coverings, especially carpets, to floors using double-sided carpet-laying tapes or double-sided self-adhesive tapes. For a floor covering to be laid on a floor, these adhesive tapes customarily consist of a carrier material with a polymeric film that is furnished on either side with a coating of pressure-sensitive adhesive. An advantage of a floor covering bond produced with an adhesive tape of this kind is that a peel adhesion is developed immediately. Over the long term, however, under certain load conditions, the possibility can exist that the peel adhesion to the floor covering is under certain circumstances not so high as it is in the case of the above-described liquid contact adhesives, since the adhesive coating of such an adhesive tape—in contrast to the situation with the above-described contact adhesives—is unable to flow into the carpet backing in order thus to enter into a permanent and particularly firm bond with all usual commercial backings of such floor coverings. Accordingly, at particularly well-used foot traffic sites, which may be subject to increased shearing and tensile loads and also to increased friction, a floor covering fastened correspondingly may detach again over time or may bulge out at such sites. Since corresponding self-adhesive films adhere particularly well especially to smooth backings of floor coverings, the problem outlined may be further exacerbated on fabric-based or textile-based carpet backings, which account for the great majority.

Furthermore, especially in aircraft engineering, there are further, specific requirements imposed on all the materials used. These materials are required fundamentally to have certain properties in order that they can be or are allowed to be used.

First of all, they are required to be extremely nonflammable, or generally to offer good fire protection.

An additional requirement of adhesive tapes used for bonding floor coverings in the aisles of aircraft is that they are extremely lightweight, so as to provide a weight saving which, while small, is nevertheless not negligible, with the aim of reducing the fuel costs and increasing the load capacity by comparison with alternative solutions.

The floor coverings in aircraft aisles (or similar vehicles) must then be replaced regularly, on account of the considerable loads to which they are subject. In this context it is necessary that the adhesive tapes used for the bond are removable without residue in particular from the subsurface, so as to be able to avoid costly and laborious cleaning work. On the other hand, the adhesive tapes are intended to provide for permanent and reliable anchoring of a floor covering on a floor even in particularly high-traffic areas, such as in the aisles of an aircraft.

During the application of the floor covering on the floor, therefore, a high initial bond strength is very important. This is especially true in those cases where the floor covering takes the form of a sheetlike material which is unrolled only shortly before or during the application. In these cases, the acquired curvature of the material may result in the floor covering standing up, especially at the bond margins. That leads to increased loading of the bond area. For residue-free redetachability, moreover, a critical factor is that the initial peel adhesion forces do not increase over the service life.

It is an object of the invention to indicate a possibility of opening up access to technical applications, particularly to the bonding of temporary substrates such as textile floor coverings on permanent substrates such as floors, in an aircraft, for example, to self-adhesive compounds based on (natural) rubber that have a lower density than customary adhesives, that exhibit sufficient peel adhesion, that are very largely residuelessly redetachable, and that display an improvement in flame retardancy.

This object is achieved by means of a self-adhesive compound as recorded in the main claim. The dependent claims relate to advantageous developments of the subject matter of the invention. The invention further encompasses the use of this self-adhesive compound.

The invention relates accordingly to a self-adhesive compound consisting of a mixture comprising rubber, more particularly natural rubber, and also tackifier resins, the fraction of the tackifier resins being 70 to 130 phr, preferably 80 to 120 phr, and also expanded polymeric microspheres.

The figures given below in phr denote parts by weight of the relevant component per 100 parts by weight of all elastomeric or rubber polymer components of the PSA (solid/solid), in other words (natural rubber) component or other elastomers, and hence, for example, without taking account of the (polymeric) tackifier resins.

The weight % datum below is always based on the composition of the overall PSA.

Self-adhesive compounds, also called pressure-sensitive adhesives (PSAs), for the purposes of the invention are, in particular, those polymeric compositions which—as a result, optionally, of suitable additization with further components such as tackifier resins, for example—are permanently tacky and adhesive at the temperature of use (unless otherwise defined, at room temperature) and adhere on contact to a multitude of surfaces, more particularly adhering immediately (exhibiting what is called “tack” [tackiness or touch-tackiness]). Even at the temperature of use, without activation by solvent or by heat—but typically through the influence of a greater or lesser pressure—they are capable of sufficiently wetting a substrate for bonding so that interactions sufficient for the adhesion are able to develop between the composition and the substrate. Influencing parameters that are essential in this respect include the pressure and the contact time. The particular properties of the PSAs are attributable in particular, among other things, to their viscoelastic properties. Hence, for example, weakly or strongly adhering adhesives can be produced, as can those which are bondable just once and permanently, so that the bond cannot be parted without destruction of the bonding means and/or of the substrates, or bonds which are readily redetachable and may be able to be bonded repeatedly.

PSAs may be produced in principle on the basis of polymers of a variety of chemical natures. The pressure-sensitive properties are affected by factors including the nature and the proportions of the monomers used in the polymerization of the polymers forming the basis for the PSA, the average molar mass and molar mass distribution of these polymers, and also the nature and amount of the adjuvants to the PSA, such as tackifier resins, plasticizers, and the like.

In order to achieve the viscoelastic properties, the monomers on which the parent polymers of the PSA are based, and also any further components of the PSA that may be present, are selected more particularly such that the PSA has a glass transition temperature (according to DIN 53765) below the temperature of use (that is, customarily below the room temperature).

By means of suitable cohesion-boosting measures, such as, for example, crosslinking reactions (formation of bridge-forming links between the macromolecules), it is possible to enlarge and/or shift the temperature range within which a polymer composition has pressure-sensitive adhesive properties. The sphere of use of the PSAs may therefore be optimized by an adjustment between flowability and cohesion of the composition.

A PSA has permanent pressure-sensitive adhesion at room temperature, hence having a sufficiently low viscosity and a high touch-tackiness, so that it wets the surface of the respective bond substrate even at low applied pressure. The bondability of the adhesive derives from its adhesive properties, and the redetachability from its cohesive properties. On account of their composition, the PSAs of the invention are redetachable.

In accordance with the invention the adhesive comprises rubber, especially natural rubber. Additionally, the adhesive of the invention may comprise synthetic rubbers such as, for example, synthetic rubber or the synthetic rubbers from the group of randomly copolymerized styrene-butadiene rubbers (SBR), butadiene rubbers (BR), synthetic polyisoprenes (IR), butyl rubbers (IIR), halogenated butyl rubbers (XIIR), polyacrylates, acrylate rubbers (ACM), polybutadienes (PB), ethylene-vinyl acetate copolymers (EVA), and polyurethanes, and/or blends thereof, individually or in any desired form of blending, including with natural rubber.

The particularly preferred natural rubber or the natural rubbers may be selected in principle from all available grades such as, for example, crepe, RSS, ADS, TSR or CV products, according to required level of purity and level of viscosity.

To improve the processability, thermoplastic elastomers such as, for example, synthetic rubbers may preferably be added with a fraction of up to 5 wt % to the natural rubber. Particular representatives that may be mentioned at this point are the particularly compatible styrene-isoprene-styrene (SIS) and styrene-butadiene-styrene (SBS) products. The base polymer of the PSA preferably consists of natural rubber, and more preferably besides natural rubber there is no further elastomeric polymer present in the PSA.

In this case the PSA is a composition of natural rubber, one or more tackifier resins, preferably aging inhibitor(s), and expanded polymeric microspheres, this representing one preferred embodiment. Additionally, furthermore, it is possible optionally for the fillers and/or dyes that are elucidated later on to be included in small quantities.

The designation “tackifier resin” denotes, to the skilled person, a resin-based substance which increases the tack.

As tackifier resins it is possible, in the case of the self-adhesive compound, for example, to use hydrogenated and unhydrogenated hydrocarbon resins and polyterpene resins, in particular, as the main component. Suitable with preference, among others, are hydrogenated polymers of dicyclopentadiene (for example, Escorez 5300 series; Exxon Chemicals), hydrogenated polymers of preferably C₈ and C₉ aromatics (for example, Regalite and Regalrez series; Eastman Inc., or Arkon P series; Arakawa). These may emerge as a flow through hydrogenation of polymers from pure aromatic streams or else may be based through hydrogenation of polymers based on mixtures of different aromatics. Also suitable are partially hydrogenated polymers of C₈ and C₉ aromatics (for example, Regalite and Regalrez series; Eastman Inc., or Arkon M; Arakawa), hydrogenated polyterpene resins (for example, Clearon M; Yasuhara), hydrogenated C₅/C₉ polymers (for example, ECR-373; Exxon Chemicals), aromatic-modified, selectively hydrogenated dicyclopentadiene derivatives (for example Escorez 5600 series, Exxon Chemicals). The aforesaid tackifier resins may be used either alone or in a mixture.

Other unhydrogenated hydrocarbon resins, unhydrogenated analogs of the hydrogenated resins described above, can also be used.

Moreover, rosin-based resins (for example, Foral, Foralyn) can be used.

The aforementioned rosins include, for example, natural rosin, polymerized rosin, partially hydrogenated rosin, fully hydrogenated rosin, esterified products of these kinds of rosin (such as glycerol esters, pentaerythritol esters, ethylene glycol esters, and methyl esters), and rosin derivatives (such as disproportionation rosin, fumaric acid-modified rosin, and lime-modified rosin).

Tackifier resins preferred in accordance with the invention are (partially) hydrogenated hydrocarbon resins based on C₅, C₅/C₉ or C₉, and also polyterpene resins based on α-pinene and/or β-pinene and/or δ-limonene, and also terpene-phenolic resins.

Especially preferred are terpene-phenolic resins, and more particularly just terpene-phenolic resins, without other types of resin being used.

To stabilize the PSA it is common to add primary antioxidants such as, for example, sterically hindered phenols, secondary antioxidants such as, for example, phosphites or thioethers and/or C-radical scavengers.

For the natural rubber-based PSA it is possible, for the purpose of adjusting optical and technical adhesive properties, for additives to be included such as fillers, dyes or aging inhibitors (antiozonants, light stabilizers, etc.).

Additives to the adhesive that are typically utilized are as follows:
primary antioxidants such as, for example, sterically hindered phenols
secondary antioxidants such as, for example, phosphites or thioethers
light stabilizers such as, for example, UV absorbers or sterically hindered amines

The fillers may be reinforcing or nonreinforcing. Particularly noteworthy here are silicon dioxides (spherical, acicular or irregular such as pyrogenic silicas), calcium carbonates, zinc oxides, titanium dioxides, aluminum oxides or aluminum oxide hydroxides.

The concentration of the additives influencing the optical and technical adhesive properties is preferably up to 20 wt %, more preferably up to 15 wt %.

The substances recited are not mandatory; the adhesive also functions without the addition thereof individually or in any desired combination, in other words without fillers and/or dyes and/or aging inhibitors.

The foam is obtained by expanded polymeric microspheres.

Microspheres, also called “microballoons”, are elastic hollow microspheres, which accordingly can be expanded in their basic state, and which have a thermoplastic polymer shell. These spheres are filled with low-boiling liquids or with liquefied gas. Shell material used includes, in particular, polyacrylonitrile, PVDC, PVC or polyacrylates. Suitable low-boiling liquids are, in particular, hydrocarbons of the lower alkanes, such as isobutane or isopentane, for example, which are included in the form of liquefied gas under pressure in the polymer shell.

Action on the microballoons, and more particularly the action of heat, causes the outer polymer shell to soften. At the same time, the liquid blowing gas present within the shell undergoes transition into its gaseous state. This is accompanied by irreversible stretching of the microballoons, which expand three-dimensionally. Expansion is over when the internal pressure matches the external pressure. Since the polymeric shell is retained, a closed-cell foam is obtained accordingly.

There are a large number of types of microballoon available commercially, which differ essentially in their size (6 to 45 μm in diameter in the unexpanded state) and the onset temperatures they require for expansion (75 to 220° C.). One example of commercially available microballoons are the Expancel® DU products (DU=Dry Unexpanded) from Akzo Nobel.

Unexpanded types of microballoon are also available as an aqueous dispersion having a solids or microballoon fraction of around 40 to 45 wt %, and additionally in the form of polymer-bound microballoons (masterbatches), as for example in ethyl vinyl acetate with a microballoon concentration of around 65 wt %. The microballoon dispersions and the masterbatches as well, like the DU products, are suitable for producing a foamed PSA of the invention.

Foaming may also be produced with what are called preexpanded microballoons. In the case of this group, the expansion takes place prior to incorporation into the polymer matrix. Preexpanded microballoons are available commercially, for example, under the designation Dualite® or with the product name Expancel xxx DE yy (Dry Expanded) from Akzo Nobel. “xxx” stands for the composition of the microballoon blend. “yy” stands for the size of the microballoons in the expanded state.

The microballoons are preferably chosen such that the ratio of the density of the polymer matrix to the density of the (non-preexpanded or only a little preexpanded) microballoons for incorporation into the polymer matrix is between 1 and 1:6, i.e.:

$$\frac{Density of polymer matrix}{Density of microballoons for incorporation} = 1 to 1.6 .$$

Expansion then takes place only after or directly during the incorporation. In the case of solventborne compositions, the microballoons are preferably not expanded until after incorporation, coating, drying (solvent evaporation).

In accordance with the invention, preference is therefore given to using DU products.

With preference in accordance with the invention, at least 90% of all the voids in the PSA formed by microballoons have a maximum diameter of 10 to 200 μm, more preferably of 15 to 150 μm. The “maximum diameter” means the maximum extent of a microballoon in any three-dimensional direction.

The diameters are determined using a cryofracture edge under a scanning electron microscope (SEM) at 500 times magnification. The diameter of each individual microballoon is determined graphically.

The microballoons may be supplied in the form of a batch, paste or an unextended or extended powder to the formulation. They may additionally be present in suspension in solvent.

According to one preferred embodiment of the invention, the fraction of the microballoons in the PSA is between greater than 0 wt % and 30 wt %, more particularly between 1.5 wt % and 10 wt %, based in each case on the overall composition of the PSA.

The figures are based in each case on unexpanded microballoons.

A PSA which comprises expanded polymeric microspheres may also in part include microspheres which are not fully expanded or are not expanded at all. In the operation, instead, a distribution of different states of expansion is established.

In the sense of the invention this means that expanded microballoons encompass both fully and partly expanded microballoons. Unexpanded microballoons may additionally be present.

A polymer composition that comprises expandable hollow microspheres may additionally also include unexpandable hollow microspheres. The only critical issue is that almost all of the gas-containing enclosures are closed by a permanently impervious membrane, regardless of whether this membrane consists of an elastic and thermoplastically stretchable polymer mixture or, for instance, of glass which is elastic and/or is nonthermoplastic in the spectrum of the temperatures possible in plastics processing.

Additionally suitable for the PSA—and selected independently of other additives—are solid polymer spheres such as PMMA spheres, hollow glass spheres, solid glass spheres, phenolic resin spheres, hollow ceramic spheres, solid ceramic spheres and/or solid carbon spheres (“carbon microballoons”); preferably, the PSA does not contain the stated constituents.

The absolute density of the foamed PSA is preferably 350 to 900 kg/m³, more preferably 450 to 700 kg/m³, more particularly 500 to 600 kg/m³.

The relative density describes the ratio of the density of the foamed PSA to the density of the unfoamed PSA of identical formula. The relative density of the PSA is preferably 0.35 to 0.99, more preferably 0.45 to 0.97, more particularly 0.50 to 0.90.

The foamed PSA represents a syntactic foam. In a syntactic foam, the voids are separate from one another and the substances present in the voids (gas, air) are separated by a membrane from the surrounding matrix. As a result, the material is substantially stronger than conventional foams with unreinforced gas inclusions.

The PSA preferably consists of the following constituents:

Pressure-sensitive adhesive comprising
a) 30 wt % to 59.9 wt %, preferably 45 wt % to 53.5 wt %, of natural rubber
b) 40 wt % to 69.9 wt %, preferably 45 wt % to 55 wt %, of terpene-phenolic resin
c) 0.1 wt % to 30 wt %, more particularly between 1.5 wt % and 10 wt %, of expanded polymeric microspheres (based on unexpanded microballoons).

More preferably the PSA consists of the following constituents:

Pressure-sensitive adhesive comprising
d) 30 wt % to 59.9 wt %, preferably 45 wt % to 53.5 wt %, of natural rubber
e) 40 wt % to 69.9 wt %, preferably 45 wt % to 55 wt %, of at least one tackifier resin, more particularly terpene-phenolic resin
f) 0.1 wt % to 30 wt %, more particularly between 1.5 wt % and 10 wt %, of expanded polymeric microspheres (based on unexpanded microballoons) and
g) 0 wt % to 20 wt %, preferably up 5 to 10 wt %, of further additives.

With further preference the composition of the adhesive is as follows:

Pressure-sensitive adhesive comprising
a) 45 wt % to 53.5 wt % of natural rubber
b) 45 wt % to 55 wt % of terpene-phenolic resin
c) 1.5 wt % to 10 wt % of expanded polymeric microspheres (based on unexpanded microballoons) and
d) 0 wt % of further additives.

Surprisingly, and for the skilled person in no way at all foreseeably, a PSA of the invention foamed with microballoons passes the flame test, as the examples show. This is very surprising insofar as the microballoons use blowing agents in the form of highly flammable gases such as isobutane and/or pentane. This means that a foamed PSA of the invention displays better fire performance than an unfoamed PSA of the same composition in the same layer thickness, despite the foamed PSA having a much greater surface area available and despite the incorporation into the adhesive of combustible gases such as isobutane and/or pentane.

Even though the PSA of the invention passes the flame test even without the addition of flame retardants, it may be necessary, for certain applications, to increase the flame retardancy still further by addition of additional flame retardants. The skilled person is aware from the prior art of a large number of different flame retardants. These retardants differ not only in their mechanism of action but also in their chemical construction. For use in the PSA of the invention, critical factors are high compatibility with the polymer matrix and also influence on the density of the overall system. Additionally, the addition of flame retardant, as of other fillers too, may adversely impact the peel adhesion. A host of flame retardants are suitable for use in the PSA of the invention. Flame retardants which have proven particularly suitable are those based on organophosphorus compounds (for example, DOPO or a reaction product of DOPO with a further compound wherein the H of the p_H bond is substituted by an organic radical). In any case, no halogenated flame retardants are added to the PSA of the invention. Because of the good flame retardancy properties of the PSAs of the invention, the fraction of flame retardants, when added, can be reduced significantly by comparison with existing PSAs.

Preference is given to using 0 wt % to 20 wt %, preferably to 5 to 10 wt %, of flame retardants, with at the same time no other additives being used.

As already described, it is very important, for the use of the PSA of the invention for bonding temporary substrates to permanent substrates, that no residues are left on the permanent substrate when the PSA is removed.

Advantageously for this purpose the cohesion of the composition is set at a sufficiently high level. One of the ways in which this can be achieved is also crosslinking the PSA or parts of the PSA, such as the base polymer, for example. For this purpose there are a host of known chemical or physical methods. For unsaturated elastomers, especially the particularly suitable natural rubber, electron beams may be used, as well as sulfur crosslinking or resole crosslinking. Such beams ensure radical formation and subsequent crosslinking of the isoprene units. Downstream crosslinking of this kind is important particularly in the context of the compounding of the PSA of the invention in an extruder. The shearing forces that arise during the extrusion may result in a decrease in the molar weight of the natural rubber polymer chains, in association with a reduction in the cohesion. The skilled person knows of this process as mastication. Consequently, crosslinking and hence a reestablishment of the polymer network are highly important here. Accordingly, the PSAs of the invention are preferably crosslinked, and in the case of isoprene-based rubbers are crosslinked preferably using electron beams. This prevents, or at least reduces, cohesive splitting of the composition on redetachment and hence the leaving-behind of a high proportion of residues. Irradiation with electrons may bring about an improvement. In this case the dose must in particular be selected such that the peel adhesion is not lowered too far by the crosslinking; the skilled person is aware of the dose to be selected.

The PSA is utilized preferably in adhesive tapes.

Adhesive tapes in the sense of the invention are to comprehend all sheetlike or tapelike carrier formations coated on one or both sides with the adhesive of the invention, hence including, in addition to conventional tapes, also labels, sections, diecuts (punched sheetlike carrier formations coated with adhesive), two-dimensionally extended structures (for example, sheets) and the like, and multilayer arrangements.

The expression “adhesive tape” also encompasses, furthermore, what are called “adhesive transfer tapes”, in other words adhesive tapes without carrier. In the case of an adhesive transfer tape, instead, the adhesive is applied between flexible liners prior to application, these liners being provided with a release layer and/or having antiadhesive properties. For application, generally speaking, first one liner is removed, the adhesive is applied, and then the second liner is removed.

A liner (release paper, release film) is not part of an adhesive tape or label, but merely a tool for the production or storage thereof or for the further processing thereof by diecutting. Furthermore, in contrast to an adhesive tape carrier, a liner is not joined firmly to a layer of adhesive.

Besides the stated adhesive transfer tapes, preference is given to double-sided adhesive tapes, in which the carrier, more particularly the carrier film, is furnished on both sides with the PSA of the invention.

The adhesive tape may be provided in fixed lengths, such as in the form of meter-length product, for example, or else as continuous product on rolls (Archimedean spiral).

The coat weight (coating thickness) of the adhesive (whether on a liner or whether in the sum total of the two layers of adhesive on a carrier film) is preferably between 10 and 300 g/m², more preferably between 15 and 250 g/m², very preferably between 15 and 200 g/m².

With further preference, a double-sided self-adhesive tape has an asymmetrical construction in which the two sides are coated with a different coat weight of the PSA or PSAs. In this case the coat weight on one side is between 10 and 100 g/m² and the coat weight on the other side is between 50 g/m² and 300 g/m².

Carrier materials used for the pressure-sensitive adhesive tape are the carrier materials customary and familiar to the skilled person, such as paper, woven fabric, nonwoven, or films made, for example, of polyester such as polyethylene terephthalate (PET), polyethylene, polypropylene, oriented polypropylene, polyvinyl chloride. Particularly preferred carrier materials are those which have only very little stretchability or none, such as BOPP and especially PET.

Materials used for the film are polyesters, especially polyethylene terephthalate, polyamide, polyimide, or mono- or biaxially oriented polypropylene. Also possible, likewise, is the use of multilayer laminates or coextrudates.

The film is preferably a single-layer film.

In order to achieve very good results for the roughening it is advisable to use, as reagent for etching of the film, trichloroacetic acid (Cl₃C—COOH) or trichloroacetic acid in combination with inert crystalline compounds, preferably silicon compounds, more preferably [SiO₂]ₓ.

The purpose of the inert crystalline compounds is to be incorporated into the surface of the PET film in order thereby to increase the roughness and the surface energy.

The thickness of the film according to one preferred embodiment is between 5 and 250 μm, preferably between 6 and 120 μm, more particularly between 12 and 100 μm, very particularly between 12 and 50 μm.

Preferably the film consists of polyethylene terephthalate and has a thickness of between 12 and 50 μm.

The carrier films, furthermore, may comprise other additives such as UV protectants or else halogen-free flame retardants.

One suitable film is available under the tradename Hostaphan® RNK. This film is highly transparent, biaxially oriented, and consists of three coextruded layers.

In order to produce the film it may be appropriate to add additives and further components which improve the film-forming properties, reduce the tendency for crystalline segments to form, and/or deliberately improve or else possibly impair the mechanical properties.

The tensile strength of the film is preferably greater than 100 N/mm², more preferably greater than 180 N/mm² (in lengthwise direction), and greater than 200 N/mm², preferably greater than 270 N/mm² (in cross direction).

The elongation at break of the film is preferably less than 300 N/mm², more preferably greater than 200 N/mm² (in lengthwise direction), and less than 300 N/mm², preferably greater than 120 N/mm² (in cross direction).

The film authoritatively determines the tensile strength and elongation at break of the pressure-sensitive adhesive strip. The adhesive tape comprising the film carrier preferably has the same tensile strength and elongation at break values as those indicated above.

The carrier material may be furnished on one or preferably on both sides with the PSA of the invention. In the case of the adhesive tape furnished double-sidedly with the PSA of the invention, the PSA of the invention forms at least one layer.

The pressure-sensitive adhesive tape is formed by application of the adhesive, partially or over the whole area, to the carrier. Coating may also take place in the form of one or more strips in lengthwise direction (machine direction), optionally in cross direction, but coating more particularly is over the full area. Furthermore, the adhesives may be applied in patterned dot format by means of screen printing, in which case the dots of adhesive may also differ in size and/or distribution, or by gravure printing of lines which join up in the lengthwise and cross directions, by screen printing, or by flexographic printing. The adhesive may be in the form of domes (produced by screen printing) or else in another pattern such as lattices, stripes, zig-zag lines. Furthermore, for example, it may also have been applied by spraying, producing a more or less irregular pattern of application.

It is advantageous to use an adhesion promoter, referred to as a primer layer, between carrier and adhesive, or to use a physical pretreatment of the carrier surface for the purpose of improving the adhesion of the adhesive to the carrier.

Primers which can be used are the known dispersion systems and solvent systems, based for example on isoprene- or butadiene-containing rubber, acrylate rubber, polyvinyl, polyvinylidene and/or cyclo rubber. Isocyanates or epoxy resins as additives improve the adhesion and in some cases also increase the shear strength of the PSA. The adhesion promoter may likewise be applied by means of a coextrusion layer on one side of the carrier film. Examples of suitable physical surface treatments are flame treatment, corona or plasma, or coextrusion layers.

Furthermore, the carrier material, on the reverse face or upper face (in the case of a single-sidedly adhesively furnished adhesive tape), in other words opposite the adhesive side, may have been subjected to an antiadhesive physical treatment or coating, and more particularly may have been furnished with a release agent or release (optionally blended with other polymers).

Examples are stearyl compounds (for example, polyvinylstearylcarbamate, stearyl compounds of transition metals such as Cr or Zr, ureas formed from polyethylenimine and stearyl isocyanate, or polysiloxanes. The term stearyl stands as a synonym for all linear or branched alkyls or alkenyls having a C number of at least 10 such as octadecyl, for example.

Suitable release agents further include surfactant-type release systems based on long-chain alkyl groups such as stearylsulfosuccinates or stearylsulfosuccinamates, but also polymers which may be selected from the group consisting of polyvinylstearylcarbamates such as, for example, Escoat 20 from Mayzo, polyethyleniminestearylcarbamides, chromium complexes of C₁₄ to C₂₈ fatty acids, and stearyl copolymers, as described in DE 28 45 541 A, for example. Likewise suitable are release agents based on acrylic polymers with perfluorinated alkyl groups, silicones based, for example, on poly(dimethylsiloxanes), or fluorosilicone compounds.

The carrier material may further be pretreated and/or aftertreated. Common pretreatments are hydrophobizing, corona pretreatments such as N₂ corona or plasma pretreatments; familiar aftertreatments are calendering, heating, laminating, punching, and enveloping.

The adhesive tape may likewise have been laminated with a commercial release film or release paper, which customarily comprises a base material of polyethylene, polypropylene, polyester or paper which has been coated with polysiloxane on one or both sides.

The pressure-sensitive adhesive tape of the invention preferably has a peel adhesion on an aluminum subsurface of at least 2.0 N/cm, more preferably at least 6.0 N/cm, and very particularly at least 8.0 N/cm.

For efficient production it is a great advantage to manufacture a double-sidedly adhesive self-adhesive tape with only one formula, in order to minimize the cost and complexity of cleaning the plant components.

In the case of adhesive tapes manufactured with the PSA of the invention, however, it is advantageous that the two external adhesive layers are configured in such a way that they have similar bond strengths on both subsurfaces to be bonded.

This is true especially in the context of the bonding of textile floor coverings to subsurfaces.

Because the substrates to be bonded prove to have different affinities, the two sides must exhibit highly different peel adhesion forces on a subsurface. In order not to have to manufacture an adhesive tape with two different formulas, it has proven advantageous to adapt the layer thicknesses of the two sides. The layer thickness which is bonded with the subsurface of lower affinity ought to be greater. For the substrates used in practice, a layer thickness ratio of greater than/equal to 1:2, but more particularly 1:4, has proven advantageous.

Also advantageous is the setting of this bond strength gradient via control of the density of the two layers. For this purpose it is entirely sufficient to vary only a proportion of a formula constituent, preferably the proportion of the microballoons. Because of the great width of bonding substrates, the ratio of the two layer-thickness ratios or density ratios may become so great that for one side of the article of the invention a substantially unfoamed, thin layer of adhesive is employed.

For reliable bonding of the temporary substrate, it is important that the PSA exhibits sufficiently high peel adhesion both to the temporary substrate (carpet) and to the permanent substrate (aircraft floor). PSAs of the invention therefore preferably have a peel adhesion on the carpet backing side of greater than 0.5 N/cm, preferably greater than 1 N/cm, and especially preferably greater than 2 N/cm. The measurement of the peel adhesion on the carpet here takes place analogously to the measurement of the peel adhesion on a steel plate, with a strip of the carpet being affixed to a steel plate beforehand, by means for example of a double-sided adhesive tape (having a sufficiently high peel adhesion), by the top face.

The peel adhesion of an adhesive based, for example, on natural rubber is customarily adjusted via the weight ratio of the natural rubber to the tackifier resin or by the addition of plasticizers. It has emerged that for compositions which contain microballoons and are therefore foamed, the choice of the tackifier resin is also of critical importance. With tackifier resins based on polyterpenes or other hydrocarbons (C₅ resins C₅/C₉ resins, (partially) hydrogenated variants of C₅ or C₅/C₉ resins) in some cases the bond strengths achieved are not sufficiently high. Particular preference is therefore given to terpene-phenolic resins, since they can be used to produce sufficiently strongly adhering compositions.

In accordance with the invention, the adhesive tape formed with the PSA is utilized to bond a temporary substrate temporarily to a permanent substrate.

According to one preferred embodiment, the temporary substrate is a textile floor covering such as a carpet, and the permanent substrate is a subsurface, preferably a metallic subsurface, more particularly aluminum, as installed in aircraft floors.

Floor coverings can be divided into textile coverings (carpet flooring, fitted carpet) and nontextile coverings. Nontextile coverings include elastic coverings such as homogeneous plastic coverings (PVC and polyolefin coverings), multilayer plastic coverings, linoleum or cork coverings. Also counting are hard coverings (laminate floors or wood-block), and lastly also tiles or stone flags.

Carpet flooring (also carpeting, fitted carpet) refers to a textile floor covering. Carpet flooring is any textile floor covering which can be laid over the full area in a room.

Carpet flooring consists of a plurality of layers, of the support layer and the wear layer. The upper layer, the wear layer (pile), consists of fibers. The fibers may be synthetic, natural, or a blend. With some carpet flooring, a middle layer then follows, with adhesive which joins the fibers to the woven fabric support. The bottom layer (support layer) is the carpet flooring backing, which may likewise consist of natural or synthetic materials.

When the temporary substrate in the form of the carpet is damaged and/or soiled, it is to be able to be parted from the permanent substrate, along with the PSA of the invention. As few residues as possible of the temporary assembly are to remain on the permanent substrate.

The adhesive of the invention meets these requirements.

The concept of the invention embraces an adhesive tape with the PSA of the invention, the PSA having been applied as one layer to a liner, in particular at a thickness of between 10 μm and 3000 μm, preferably between 10 μm and 150 μm.

Additionally within the concept of the invention is an adhesive tape with the PSA of the invention, where a carrier, more particularly a film carrier, is present in the PSA layer.

The adhesive tapes are suitable with particular advantage, on the basis of the advantages outlined and demonstrated, for the bonding of temporary substrates such as textile floor coverings to permanent substrates such as subsurfaces, especially those of aluminum.

Further details, objectives, features, and advantages of the present invention will be elucidated in more detail below by reference to a number of figures which represent preferred working examples. In these figures

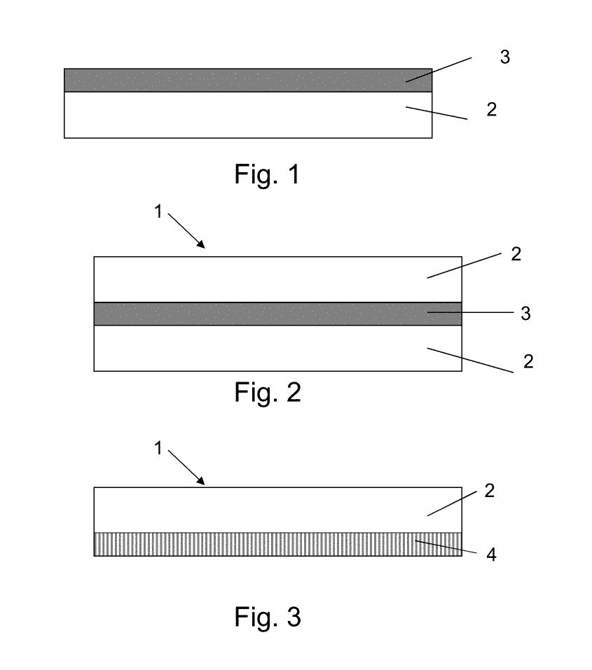

FIG. 1 shows a single-sided pressure-sensitive adhesive tape,

FIG. 2 shows a double-sided pressure-sensitive adhesive tape,

FIG. 3 shows a carrier-free pressure-sensitive adhesive tape (adhesive transfer tape).

FIG. 1 shows a single-sidedly adhering pressure-sensitive adhesive tape 1. The pressure-sensitive adhesive tape 1 has an adhesive layer 2 produced by coating one of the above-described PSAs onto a carrier 3. The PSA coat weight is preferably between 10 and 50 g/m².

Provided additionally (not shown) may be a release film, which covers and protects the adhesive layer 2 before the pressure-sensitive adhesive tape 1 is used. The release film is then removed before use from the adhesive layer 2.

The product construction shown in FIG. 2 shows a pressure-sensitive adhesive tape 1 with a carrier 3, coated on both sides with a PSA and therefore having two adhesive layers 2. The PSA coat weight per side is in turn preferably between 10 and 200 g/m².

With this embodiment as well, at least one adhesive layer 2 is preferably lined with a release film. In the case of a rolled-up adhesive tape, this one release film may optionally also line the second adhesive layer 2. However, it is also possible for a plurality of release films to be provided.

It is possible, furthermore, for the carrier film to be provided with one or more coatings. Moreover, only one side of the pressure-sensitive adhesive tape may be furnished with the inventive PSA, and a different PSA may be used on the other side.

The product construction shown in FIG. 3 shows a pressure-sensitive adhesive tape 1 in the form of an adhesive transfer tape, in other words a carrier-free pressure-sensitive adhesive tape 1. For this construction, the PSA is coated single-sidedly onto a release film 4, to form a pressure-sensitive adhesive layer 2. The PSA coat weight here is customarily between 10 and 50 g/m². This pressure-sensitive adhesive layer 2 is optionally also lined on its second side with a further release film. For the use of the pressure-sensitive adhesive tape, the release films are then removed.

As an alternative to release films it is also possible for example to use release papers or the like. In that case, however, the surface roughness of the release paper ought to be reduced, in order to realize a PSA side that is as smooth as possible.

### Test Methods

Unless otherwise indicated, the measurements are carried out under test conditions of 23±1° C. and 50±5% relative humidity.

### Peel Adhesion to Aluminum, Steel, Carpet (Backing)

The peel strength (peel adhesion) was tested in a method based on PSTC-1.

A strip of the pressure-sensitive adhesive tape 2 cm wide is adhered to the test substrate, such as, for example, a steel plate, an aluminum plate, or a strip of carpet fixed by the surface on a solid steel subsurface beforehand, by being rolled on back and forth five times using a 4 kg roller. The surface of the steel or aluminum plate is cleaned with acetone beforehand; the surface of the carpet backing is not cleaned. The plate is clamped in, and the self-adhesive strip is peeled from its free end on a tensile testing machine at a peel angle of 180° and with a speed of 300 mm/min, and a determination is made of the force needed to achieve this. The measurement results are reported in N/cm and are averaged over three measurements. The result is reported as PA steel (peel adhesion to steel), PA alu (peel adhesion to aluminum), and PA carpet (peel adhesion to carpet backing).

For the measurements carried out in the context of this patent application, the Aero collection 5ED-121426 carpet from Desso Aviation Carpet was used. The good and advantageous results of the self-adhesive compounds of the invention were, however, also achieved on further, different carpets from different manufacturers.

### Flame Test

The flame tests were conducted in accordance with ASTM F501 (Airbus AITM 2.0002B). A pass is scored in the test if the maximum burning distance does not exceed 203 mm and the maximum burning time does not exceed 15 seconds. Prior to the test, the specimens were adhered on an aluminum plate and conditioned for 3 days at 23±1° C. and 50±5% relative humidity.

### Absence of Residue

In order to find a suitable measure for determining the absence of residue, a section of adhesive tape (adhesive transfer tape) with an area of 5×20 cm is adhered to a subsurface in the form of an aluminum plate. After 4-week storage at 40° C. on the permanent substrate, the adhesive tape is peeled off. The residues of composition remaining are determined by weighing of the subsurface plate, and are extrapolated to an area of one square meter.

The intention below is to illustrate the invention with a number of examples, without thereby wishing to subject the invention to unnecessary limitation.

### EXAMPLES

| | Example 1a | Example 1b | | Comparative | Example 5 |
|---|---|---|---|---|---|
| | Standard | 4 weeks | Example 2 | example 4 | HC resin |
| | Initial mass | Initial mass | Initial mass | Initial mass | Initial mass |
| Raw material | of solids [%] | of solids [%] | of solids [%] | of solids [%] | of solids [%] |
| Natural rubber | 41.0 | 41.0 | 41.0 | 41.0 | 41.0 |
| (type SVR 3L) | | | | | |
| Piccotac 1100E | | | | | 37.0 |
| Novares TK 90 | | | | | 12.0 |
| Dertophene T 105 | 49.0 | 49.0 | 49.0 | 49.0 | |
| 920 DU 40 | 5.0 | 5.0 | 5.0 | 5.0 | 5.0 |
| Chemical blowing | | | | | |
| agent | | | | | |
| azodicarboxamide | | | | | |
| Wingtack 10 | 5.0 | 5.0 | 5.0 | 5.0 | 5.0 |
| DOPO flame | | | | | |
| retardant | | | | | |
| ADP flame retardant | | | | | |
| | | Comparative | Comparative | | |
| | Comparative | example 2 | example 3 | Example 3 | Example 4 |
| | example 1 | Physical | Chemical | Flame | Flame |
| | Unfoamed | foaming | foaming | retardancy | retardancy |
| | Initial mass | Initial mass | Initial mass | Initial mass | Initial mass |
| Raw material | of solids [%] | of solids [%] | of solids [%] | of solids [%] | of solids [%] |
| Natural rubber | 43.0 | 43.0 | 42.0 | 37.3 | 33.9 |
| (type SVR 3L) | | | | | |
| Piccotac 1100E | | | | | |
| Novares TK 90 | | | | | |
| Dertophene T 105 | 51.0 | 51.0 | 51.0 | 44.5 | 40.5 |
| 920 DU 40 | | | | 5.0 | 5.0 |
| Azodicarboxamide | | | 2.0 | | |
| Wingtack 10 | 6.00 | 6.00 | 5.0 | 4.0 | 5.0 |
| DOPO flame | | | | 9.2 | |
| retardant | | | | | |
| ADP flame | | | | | 16.6 |
| retardant | | | | | |

Piccotac 1100-E aliphatic hydrocarbon resin Eastman Chemical Middleburg B. V.
920 DU 40 microballoons from Expancel
DOPO = (9,10-dihydro-9-oxy-10-phosphaphenanthrene 10-oxide)
ADP = aluminum diethylphosphinate

Using the adhesives produced according to the formulas stated above, double-sided adhesive tapes are produced, by applying the PSA to the top and bottom sides of a PET film which is 23 μm thick and has been etched on both sides with trichloroacetic acid.

Results of Measurement:

| | Example 1a | | Example 1b | | | | Comparative | | Example 5 | |
|---|---|---|---|---|---|---|---|---|---|---|
| | Standard | | 4 weeks | | Example 2 | | example 4 | | HC resin | |
| Density | 540 | kg/m³ | 540 | kg/m³ | 540 | kg/m³ | 540 | kg/m³ | 540 | kg/m³ |
| Thickness alu side | 37 | μm | 37 | μm | 64 | μm | 95 | μm | 37 | μm |
| PA alu | 5.30 | N/cm | 5.50 | N/cm | 5.80 | N/cm | 7.50 | N/cm | 4.90 | N/cm |
| Thickness carpet | 156 | μm | 156 | μm | 128 | μm | 100 | μm | 156 | μm |
| side | | | | | | | | | | |
| PA carpet | 3.50 | N/cm | 3.60 | N/cm | 2.90 | N/cm | 2.10 | N/cm | 0.80 | N/cm |
| PA alu | 10.70 | N/cm | 11.00 | N/cm | 9.10 | N/cm | 7.60 | N/cm | 8.2 | N/cm |
| Detachment from | no | | no | | no | | yes | | no | |
| carpet on removal | | | | | | | | | | |
| Layer thickness | 4.2 | | 4.2 | | 2.0 | | 1.05 | | 4.2 | |
| gradient | | | | | | | | | | |
| Flame test without | pass | | pass | | pass | | pass | | pass | |
| additional FR | | | | | | | | | | |
| Residues on alu | 4 | g/m² | 4 | g/m² | 4 | g/m² | 4 | g/m² | 4 | g/m² |
| | | | Comparative | | Comparative | | | | | |
| | Comparative | | example 2 | | example 3 | | Example 3 | | Example 4 | |
| | example 1 | | Physical | | Chemical | | Flame | | Flame | |
| | Unfoamed | | foaming | | foaming | | retardancy | | retardancy | |
| Density | 980 | kg/m³ | 630 | kg/m³ | 495 | kg/m³ | 620 | kg/m³ | 680 | kg/m³ |
| Thickness alu side | 20 | μm | 32 | μm | 40 | μm | 32 | μm | 29 | μm |
| PA alu | 6.20 | N/cm | 7.50 | N/cm | 9.20 | N/cm | 4.8 | N/cm | 4.5 | N/cm |
| Thickness carpet | 85 | μm | 135 | μm | 172 | μm | 137 | μm | 125 | μm |
| side | | | | | | | | | | |
| PA carpet | 2.90 | N/cm | 1.80 | N/cm | 2.40 | N/cm | 1.2 | N/cm | 1.7 | N/cm |
| PA alu | 9.30 | N/cm | 8.50 | N/cm | 9.80 | N/cm | 7.9 | N/cm | 7.5 | N/cm |
| Detachment from | no | | no | | no | | no | | no | |
| carpet on removal | | | | | | | | | | |
| Layer thickness | 4.2 | | 4.2 | | 4.2 | | 4.2 | | 4.2 | |
| gradient | | | | | | | | | | |
| Flame test without | fail | | fail | | pass | | pass | | pass | |
| additional FR | | | | | | | | | | |
| Residues on alu | 1 | g/m² | 13 | g/m² | 15 | g/m² | 4 | g/m² | 4 | g/m² |

Example 1b is obtained from example 1a by 4-week storage (23±1° C. and 50±5% relative humidity) in the bonded state.

For the preferred application it is important that the assembly formed of carpet (temporary substrate)/adhesive tape can be removed from the permanent substrate, even after a prolonged period of bonding, easily and without any increase in the bond strength, from the carpet without stretching. In accordance with the invention, there is no increase in the bond strength on the permanent substrate over time.

As well as the foaming with microballoons in accordance with the invention, the comparative experiments also show what are referred to as chemical and physical foaming, in which case free, unstabilized gas bubbles are generated in the polymer compound.

It is found that with both chemical and physical foaming, there is an approximately central splitting of adhesive when the adhesive tape of the invention is removed by peeling.

In accordance with the invention, products with very low density and very low residues (on the permanent substrate) can be produced. In the case of chemical and physical foaming, in contrast, there is an increase in the residues with reduction in the density.

A further feature of the PSA of the invention is that the difference between the initial peel adhesion and the peel adhesion after storage in the bonded state (40° C., 28 d) is very small. The difference is preferably at most 4 N/cm, very preferably at most 3 N/cm. In the investigations it was found in particular that compositions based on natural rubber (poly-cis-isoprene) fulfill the conditions specified above and are therefore preferred.

1. A self-adhesive mass being a mixture comprising:
rubber,
at least one tackifier resin, the fraction of the tackifier resins being 40 to 130 phr,
expanded polymeric microspheres.

2. The self-adhesive mass of claim 1,
wherein,
the fraction of the tackifier resins is 80 to 120 phr.

3. The self-adhesive mass of claim 1, wherein:
the density of the self-adhesive mass after activation of the microballoons is reduced from its initial value by 150 kg/m³.

4. The self-adhesive mass of claim 1, wherein the self-adhesive mass can be removed very largely without residue after bonding.

5. The self-adhesive mass according to claim 1, which contains a terpene-phenolic resin as a tackifier resin.

6. The self-adhesive mass of claim 1, wherein:
the fraction of the microballoons, based on the total adhesive prior to expansion, in the self-adhesive mass is between greater than 0 wt % and 30 wt %, based in each case on the overall composition of the pressure-sensitive adhesive.

7. The self-adhesive mass of claim 1 wherein:
the pressure-sensitive adhesive has the following composition:
a) 30 wt % to 59.9 wt % of natural rubber;
b) 40 wt % to 69.9 wt % of a terpene-phenolic resin;
c) 0.1 wt % to 30 wt % of expanded polymeric microspheres (the % wt. based on unexpanded microballoons).

8. The self-adhesive mass as claimed of claim 1, wherein:
the pressure-sensitive adhesive has the following composition:
a) 30 wt % to 59.9 wt % of natural rubber;
b) 40 wt % to 69.9 wt % of at least one tackifier resin based on terpene-phenolic resin;
c) 0.1 wt % to 30 wt % of expanded polymeric microspheres (the wt % based on unexpanded microballoons); and,
d) 0 wt % to 20 wt % of further additives.

9. The self-adhesive mass of claim 1, wherein
the pressure-sensitive adhesive has the following composition:
a) 45 wt % to 53.5 wt % of natural rubber
b) 45 wt % to 55 wt % of terpene-phenolic resin
c) 1.5 wt % and 10 wt % of expanded polymeric microspheres (the wt % based on unexpanded microballoons) and
d) 0 wt % of further additives.

10. The self-adhesive mass which further comprises one or more components selected from: plasticizers, aging inhibitors, processing assistants, fillers, dyes, optical brighteners, stabilizers, and flame retardants.

11. The self-adhesive mass of claim 1, wherein the rubber is natural rubber and no further elastomeric polymer is present in the self-adhesive mass.

12. The self-adhesive mass of claim 1, wherein a flame retardant based on organophosphorus compounds is present.

13. The self-adhesive mass which includes a crosslinked, pressure-sensitive adhesive.

14. A double-sided adhesive tape having at least one self-adhesive mass according to claim 1, which is pressure-sensitive, wherein and having a thickness of between 10 μm and 600 μm.

15. An adhesive tape having a self-adhesive mass according to claim 1 which is pressure-sensitive, where in a layer of pressure-sensitive adhesive there is also present a carrier.

16. An adhesive tape of claim 15, which comprises two layers of self-adhesive masses disposed on the carrier, wherein the two layers are of identical formulation.

17. The adhesive tape of claim 16, where the two layers of self-adhesive masses have a layer thickness ratio of greater than 1.

18. An adhesive tape of claim 16, where the two layers of self-adhesive masses have different densities.

19. The adhesive tape of claim 15, wherein one of the two layers of self-adhesive masses is unfoamed.

20. A method of bonding a temporary substrate to a permanent substrate, the method comprising the step of:
utilizing the adhesive tape of claim 14 between the temporary substrate and the permanent substrate.
